(19) United States
(12) Patent Application Publication
(10) Pub. No.: US 2025/0148723 A1
(43) Pub. Date: May 8, 2025

(54) METHOD FOR SIMULATING AN APPLICATION OF A COSMETIC MAKE-UP PRODUCT TO A BODY SURFACE

(71) Applicant: L'Oreal, Paris (FR)

(72) Inventors: Alexandre Bouchez, Paris (FR); Theo Phan Van Song, Paris (FR); Yue Qiao, Paris (FR)

(73) Assignee: L'Oreal, Paris (FR)

(21) Appl. No.: 18/833,722

(22) PCT Filed: Jan. 5, 2023
(86) PCT No.: PCT/EP2023/050196

§ 371 Date: Jul. 26, 2024

(30) Foreign Application Priority Data
Jan. 28, 2022 (FR) FR2200757

(51) Int. Cl. G06T 19/00; G06T 7/40; G06T 7/90; G06T 15/04

(52) U.S. Cl. CPC G06T 19/00; G06T 7/40; G06T 7/90; G06T 15/04; G06T 2207/10024; G06T 2207/30088; G06T 2207/30201

(57) ABSTRACT

The present invention relates to a method for simulating an application of a make-up product to a body surface. comprising implementing a rendering engine configured to apply a make-up effect comprising at least one colour transformation to at least a portion of incoming image data comprising the body surface to be virtually made-up. and to generate transformed image data simulating said application of make-up product according to at least one colour parameter characteristic of the make-up product to be virtually applied. characterized in that it comprises a prior step of determining said characteristic colour parameter comprising:-acquiring a colour datum of said body surface to be virtually made-up; -acquiring a value of the characteristic colour parameter of the make-up product as a function of said colour data of the body surface to be virtually made-up.

The present invention relates to a method for simulating an application of a cosmetic make-up product to a body surface.

A “cosmetic product” is understood to mean any product as defined in Regulation (EC) No. 1223/2009 of the European Parliament and of the Council dated 30 Nov. 2009 relating to cosmetic products. A cosmetic make-up product is more specifically intended to cover a body surface with a view to modifying the perceived colour and/or the texture thereof.

The present application more specifically relates to simulating an application of a coloured product for the lips or a foundation for the skin. However, it can be applied to simulating an application of hair colouring products or nail polish.

The selection of a satisfactory make-up product can be a challenge for a user, as the choice of products, and in particular of shades, is so vast. In particular, the user is confronted with the fact of having to buy and try-on several products, which can be very discouraging for them, especially if they consider that the results of all or some of the products that they have tried-on are disappointing. Moreover, while it is still relatively easy to apply and remove lipstick or foundation, such a try-on method is much more problematic for hair colourings and nail varnishes.

The wide deployment of digital technologies in society has allowed augmented reality software to be developed and proposed that allows a user to virtually try-on cosmetic products. Thus, L′OREAL (https://www.loreal.com/en/articles/science-and-technology/l-oreal-modiface-brings-ai-powered-virtual-makeup-try-ons-to-amazon/), MAYBELLINE (https://www.maybelline.com/virtual-try-on-makeup-tools) and NYX (https://www.nyxcosmetics.com/try-it-on.html), for example, each propose the possibility of virtually trying-on make-up products from their respective ranges. In general, such software allows, from a digital image of a user, a corresponding image to be computed and generated showing the make-up effect that is likely to be acquired by applying the considered product. Such systems are known for virtually trying-on foundations, lipsticks or hair colouring, just as they exist for clothing or eyeglasses.

By virtue of such systems, a user can easily directly and immediately assess the make-up result of several products without having to buy them, or apply and remove make-up.

Examples of virtual try-on methods for make-up products are described, for example, in documents US 2020/0160153 A1 and U.S. Pat. No. 9,449,412 B1, as well as in the as yet unpublished applications FR 21/06030, FR 21/11155 and FR 21/11164 in the name of the applicant.

In general, such methods implement one or more rendering engine(s) configured to apply a set of transformations or effects to an input image as a function of one or more characteristic parameter(s) corresponding to the cosmetic product to be virtually applied. These transformations particularly can include one or more segmentation step(s) particularly intended to locate and isolate the body surface to be virtually treated, before applying, among other things, shape modifications, colour modifications and texture rendering modifications. These rendering engines can use various computational methods to carry out these transformations, and in particular implement machine learning techniques and neural networks that have been trained for these purposes.

Thus, a virtual try-on system receives an image to be modified, generally a photo of a user and in particular a photo of their face, and a set of rendering parameters characteristic of a selected cosmetic product. These parameters particularly include colour and/or shape and/or texture parameters. By applying the transformations of the rendering engine to the input image as a function of the representative parameters, the virtual try-on system generates a resultant image simulating the application of the cosmetic product to the relevant body area. This resultant image is presented to the user.

In the particular case of virtually trying-on cosmetic make-up products, the colour parameter is obviously particularly important. Considering that a make-up product is applied in the form of a layer to a body surface that itself can be coloured to a certain extent, its resulting colour, and therefore perceived colour, after application depends on several factors, including its covering ability or opacity and the colour of the body surface to which it is applied.

However, for the sake of simplicity for implementation, many virtual try-on systems do not take this specific feature into account and use fixed predefined parameters. Variations in the rendering of the application of the cosmetic product according to the user can be taken into account downstream by algorithmic processing by the rendering engine. However, this processing can be complex, requiring intensive computation resources, while lacking precision in terms of colour rendering.

Recently, new systems have been developed that no longer attempt to use fixed predefined parameters, but to extract them from images of individuals wearing these products. This particularly allows, for example, a cosmetic product to be virtually tried-on, for example, a lipstick, worn by another individual, in particular a well-known personality. The problem is similar in that such a method acquires the resulting colour on the reference individual and virtually transfers it to the user without necessarily being able to make the necessary adjustments due to their own skin colour.

Thus, a requirement exists for a simple solution for improving the colour rendering of a make-up product in a virtual try-on system.

To this end, the present application provides a method for simulating an application of a make-up product to a body surface, comprising implementing a rendering engine configured to apply a make-up effect comprising at least one colour transformation to at least a portion of incoming image data comprising the body surface to be virtually made-up, and to generate transformed image data simulating said application of make-up product according to at least one colour parameter characteristic of the make-up product to be virtually applied.

The method is characterized in that it comprises a prior step of determining a value of said characteristic colour parameter comprising:
acquiring a colour datum of said body surface to be virtually made-up;
acquiring a value of the characteristic colour parameter of the make-up product as a function of said colour data of the body surface to be virtually made-up.

According to a first alternative embodiment, the colour data of said body surface to be virtually made-up is acquired from the incoming image data. According to a second alternative embodiment, the colour data of the body surface to be virtually made-up can be acquired separately, the incoming image data then can be an image of the body area made-up with a make-up product having a particular desired finish or texture.

Preferably, the colour data of the body surface to be virtually made-up is acquired from a bare body area, i.e., not made-up and, preferably, not wearing any cosmetic products.

Thus, by making provision for the rendering engine to be supplied with a value of the colour parameter that is no longer independent of the user but is determined from the colour of the body area to be made-up, it is possible to easily and directly send the rendering engine a resulting colour value adapted to the user without having to integrate additional complex transformations and computations into the rendering engine.

In other words, whereas in general, the selection of a cosmetic product with a certain shade will result in a colour parameter value sent to the rendering engine that is determined and independent of the colour of the considered body area, the present method makes provision for sending the rendering engine a colour parameter value determined not only relative to the desired make-up cosmetic product, but also relative to a body area colour, so as to introduce a characteristic colour parameter value into the rendering engine that is best suited to the user.

Thus, for a user who would like to virtually try-on a Lancôme ‘Absolu Rouge’ lipstick of shade 397 “black berry matte”, a value of the colour parameter can be acquired as a function of their lip colour. Indeed, the same lipstick applied to light skinned lips will not yield the same rendering as when it is applied to dark skinned lips. For this reason, it is important to be able to provide the rendering engine with a suitable colour parameter value and not a colour parameter value independent of the user, or even acquired on another user.

Preferably, the colour values and data are expressed as coordinates in a given colour space, in particular in a perceptibly uniform colour space such as the CIELAB colour space (in particular L*, a*, b* or using the polar coordinates L*, C*, h*). In particular, a perceptibly uniform space allows delta E colour differences representing visual differences to be easily determined. Of course, as an alternative or in addition, the colours can be expressed in other colour spaces, in particular RGB or even directly as hexadecimal computer code, in particular according to the computer processing requirements.

The method that is the subject matter of the present application more specifically relates to the virtual make-up of an area of the lips, with the cosmetic make-up product being a lip make-up product, in particular a lipstick, preferably of the solid stick type, or a lip varnish (gloss). Of course, the method also can be implemented for the virtual make-up of other body areas such as an area of skin, in particular the skin of the face or the eyelids, with the cosmetic make-up product being a foundation or an eye shadow, respectively.

According to a preferred alternative embodiment, the colour parameter value is acquired from a database associating at least one cosmetic make-up product reference with a plurality of reference colours of the considered body area. Thus, for each cosmetic product reference (for example, lipstick), the database can contain values of the colour parameter corresponding to the rendering colours of said cosmetic product on, for example, a light/medium/dark tone body area (for example, lips).

Advantageously, the value of the colour parameter characteristic of the cosmetic product is selected from the database as being that assigned to the reference colour of the considered body area that is closest to the colour of the body area to be virtually made-up, particularly acquired from the incoming image data. In particular, the proximity can be determined by computing a colour difference in the considered colour space, for example, by computing the parameter ΔE in the CIELAB space.

The use of a database containing values of the colour parameter for several reference colours of the considered body area allows a system to be maintained that is simple to access, easy to poll, and that allows a significant number of references of cosmetic products to be stored, while maintaining a sufficient degree of precision and adaptability to the colour of the body area of the user.

The values of the colour parameters for the various cosmetic products and the various reference colours of the body area can be acquired in various ways, for example, by measuring colour on products actually applied or by simulation using colorimetric rendering models (Kubelka-Munk approximation, for example) as described in the following paragraph.

As an alternative to the use of a database containing the various colour parameter values, the value of the colour parameter characteristic of the cosmetic product can be acquired by applying a colorimetric rendering model to an intrinsic or specific colour datum of the considered cosmetic product and to a colour value of the body area to be made-up, particularly acquired from the incoming image data. Thus, the colour of the body area to be virtually made-up is no longer matched with a close reference colour but is used directly to determine the value of said colour parameter to be sent to the rendering engine of the virtual try-on system. An intrinsic colour of the considered cosmetic product is understood to mean a colour that is independent of the colour of the skin surface on which it is intended to be applied. This colour can be acquired by in vitro measurement under standardized conditions, for example, after applying (by coating a layer of defined thickness, for example) the product on an opacity measurement support comprising a black coating surface and a white coating surface (“opacity chart” such as Lencta® charts) and preferably under lighting conditions that are also standardized (D65 in particular). The colour of the body surface preferably will be acquired under similar or identical lighting conditions, for example, using a device such as the CHROMASPHERE®. The image of the user supplying the rendering engine advantageously also can be taken under the same lighting conditions.

According to the operation of the rendering engine of the virtual try-on system, a value of the single colour parameter can be acquired for an overall average colour of the body surface to be virtually made-up. However, in order to improve rendering precision and given that the colour of the body surface to be virtually made-up may not be totally uniform, the body surface to be virtually made-up can be sub-divided into a plurality of smaller sub-areas, for each of which a colour parameter value can be acquired. A colour parameter value even can be acquired pixel-by-pixel if necessary.

In an advantageous additional manner, the rendering engine is able to receive a shine/matteness parameter.

Alternatively or additionally, as explained above, the colour of the body surface to be made-up can be acquired separately from the incoming image data from the bare/unmade-up body surface. The incoming image data supplied to the rendering engine can then include a body surface made-up with a product having the desired finish (matte/shiny) and/or texture, with the rendering engine only carrying out a colour transformation.

The present invention will be better understood by means of the following detailed description with reference to the appended drawings, in which:

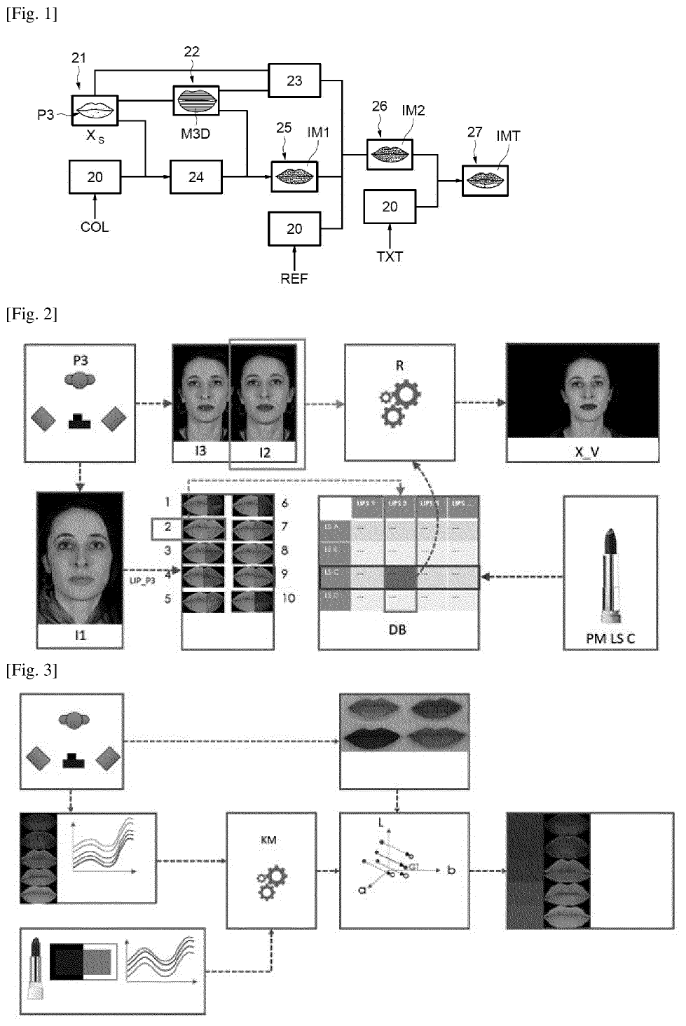

FIG. 1 shows a schematic example of a processing flow of a virtual try-on system implementing a rendering engine R configured to generate a photorealistic rendering of a lip make-up product applied to an individual;

FIG. 2 is a schematic representation of a method for determining a value of a colour parameter of the rendering engine of FIG. 1;

FIG. 3 is a schematic representation of a method for determining a rendering colour of a lip make-up product as a function of the colour of said lips, with a view to storing it in a database of the determination method of FIGS. 2 and 3 or with a view to using it directly as a colour parameter of the rendering engine of FIG. 1.

Although illustrated, by way of an example, by the virtual make-up of a surface of the lips of a user with a lipstick, the present method is applicable to other body surfaces (skin, in particular, the face, hair) and to other make-up products intended to be applied to said body surfaces. The present application particularly relates to cosmetic make-up products with a wide variety of shades and to body surfaces with a wide variety of colours among the population.

FIG. 1 shows an example of a processing flow of a virtual try-on system implementing a rendering engine R configured to generate a photorealistic rendering of a lip make-up product PM applied to an individual P3. As noted above, the generic steps that are described can be applied mutatis mutandis to other types of cosmetic products for other body surfaces.

In step 20, the rendering engine R receives characterizing parameters relating to the colour COL of the lip make-up product PM, the reflection REF of this product PM and the texture TXT of this product PM.

In step 21, the rendering engine R also receives a source image X_S of the lips of the individual P3. In step 22, the rendering engine R can then compute a model M3D of the lips of the source image X_S. In step 23, the rendering engine R can also estimate the light reflections on the lips of the source image X_S.

As is known per se, the source image X_S can be conventionally acquired by segmenting and clipping an area of interest (the lips) onto a larger image X_I of the individual, particularly including their face.

Depending on the complexity of the system, the rendering engine R can then determine, in step 24, corrected colour parameters from the colour parameters of the make-up product PM entered as input. These corrected colour parameters take into account, for example, the luminosity on the lips of the source image. The luminosity parameters can be extracted from the source image X_I and its environment. In some cases, particularly in a professional environment, the source image can be acquired under standardized conditions (see above), which are substantially identical to the conditions for determining the parameters characterizing the cosmetic product PM to be virtually tried-on. In such cases, an additional transformation may not be necessary.

Then, in step 25, the rendering engine R generates a first intermediate image IM1, in which the rendering engine applies the corrected colour parameters to the lips of the source image, taking into account the previously computed model of the lips.

In step 26, the rendering engine R then optionally generates a second intermediate image IM2, in which the entered reflection parameters are applied to the lips of the first intermediate image IM1, also taking into account the light reflections on the lips of the source image.

In step 27, the rendering engine R then optionally generates a transformed image IMT as output, in which the texture parameters entered as input are applied to the lips of the second intermediate image.

The transformed image IMT (IMT=IM1 if the optional transformation steps are not present) replaces the source image X_S on the larger image X_I so as to generate an image X_V comprising the virtually made-up area of interest that can be presented to the user.

In accordance with the present application, the value of the characterizing parameter relating to the colour COL of the cosmetic make-up product PM is acquired through a prior step of determining said parameter, an embodiment of which is schematically shown in FIG. 2.

Determining the value of the colour parameter COL of the cosmetic product PM includes acquiring a colour datum of the lips LIP_P3 of the individual P3 to be virtually made-up. This colour datum is directly acquired from an image I1 of the individual P3, preferably taken under standardized and calibrated lighting conditions (particularly D65). Optionally, it can be acquired separately, in particular using a colorimeter or a spectrophotometer. As previously indicated, the lip colour datum is acquired from the unmade-up (bare) lips of the individual.

According to the alternative embodiment, the image I1 of the individual P3 taken with bare lips can act as the incoming image X_S of the rendering engine.

Alternatively, as explained supra, the colour datum of the body surface to be virtually made-up is acquired separately from the image I1 used to acquire the colour of the lips (image of unmade-up lips). The incoming image X_S then can be an image I2 of the body area made-up with a make-up product with a particular desired finish or texture. In this case, the rendering colour of the selected lipstick is acquired from the colour of the unmade-up lips of the user (image I1). Images (I2, I3) are also acquired of the individual P3 whose body surface is made-up with a matte finish lipstick and a shiny finish lipstick, respectively. Depending on the desired finish of the cosmetic product to be virtually tried-on, either of these images can form the incoming image data X_S. The rendering engine R can then carry out a simple colour transformation and avoid additional rendering transformation computations.

From the lip colour datum LIP_P3 thus determined and the reference of the cosmetic product PM LS C to be virtually tried-on, a database DB is polled comprising, for a referenced cosmetic product, a plurality of values of the colour parameter recorded for various reference colour values of said lips.

More specifically, the database includes a table associating one or more cosmetic product references PM, in this case lipsticks LS A, LS B, LS C, LS D, with several reference lip colours LIPS 1, LIPS 2, LIPS 3. For each cosmetic product/lip colour pair (LS i; LIPS j), the database can store a colour value representing the rendering colour of the cosmetic product PM (LS i) as applied to lips of colour LIP j.

From the lip colour LIP_P3 of the individual to be virtually made-up, the closest colour LIP j(P3) is determined for which a colour value corresponding to the cosmetic product PM (LS C) is entered (in this case LIPS 2). The colour value for the cosmetic product PM (in this case LS C), as applied to the lips LIPS 2 is then extracted from the database to be sent to the rendering engine as a colour parameter COL of the cosmetic product PM (LS C) to be virtually rendered on the image of the individual P3.

The various reference lip colours can be determined by partitioning actual colour measurement data from a population sample. The colour of the lips particularly can be measured with a colorimeter or a spectrophotometer, advantageously under standardized and calibrated illumination conditions (D65, in particular using a CHROMASPHERE® device). Thus, it will be possible to determine between three and ten groups of lip colours, in particular, light, medium and dark lip colours, with optional intermediate gradations. In particular, “K-MEANS CLUSTERING” methods can be used and the lip colours can be selected from the centre of each cluster.

The colour values of the various make-up products for the various reference lip colours can be acquired by measuring the colour of the product as actually applied to lips with the corresponding colour and/or can be acquired by computing from a colour rendering model (KM) implementing, for example, a Kubelka-Munk approximation or another physical rendering model as shown in FIG. 3. The colorimetric rendering model KM simulates a colour rendered from colorimetric measurements of bare lips (ex vivo) and colorimetric measurements of the cosmetic product PM (in vitro) corresponding to an intrinsic colour value independent of the body surface colour. A colorimetric correction can be applied using a colorimetric deviation parameter that can be determined by comparison(s) between the results of colour simulations and actual values acquired on the product actually applied to the lips. All or part of such a simulation system can implement machine learning techniques, in particular for determining the colorimetric deviation parameter allowing a colour correction to be made to the theoretical physical model. Such a system is particularly described in application FR 3094201 for hair colourings.

Thus defined, the colour rendering simulation system allows the colour rendering values to be pre-computed for the various cosmetic products that can be virtually tried-on for each reference lip colour. These values are stored in the database.

In an alternative embodiment, the simulation system can directly generate a colour parameter value COL sent to the rendering engine R. In this case, a colour of the lips of the user is acquired as before and is submitted to the simulation system with the known intrinsic colour data for the cosmetic product PM to be virtually tried-on. The simulation system then feeds back a value corresponding to an estimate or prediction of the colour rendered by applying the cosmetic product PM to the lips of the user.

In order to improve the rendering of the virtual try-on system, it is also possible to send the rendering engine a matteness/shine parameter for reflecting a matte or satin finish of the virtually applied lipstick. This parameter particularly can form part of the reflection parameters that the rendering engine can be supplied with for optimizing the light rendering.

Although not described, the selection of the cosmetic product to be virtually tried-on can be conventionally carried out from an interface presenting all or part of a product catalogue for which the parameters are available and virtual trying-on is possible.

Furthermore, all or part of the steps are intended to be implemented by a computer and to this end the present application also relates to a computer program product comprising instructions, which, when the program is executed by a computer, result in the implementation of at least the characteristic steps of the method. Preferably, the program also implements the virtual try-on system and the rendering engine. The present application also relates to a system comprising a memory, in which the program product is stored. The system can also include any additional devices required for implementing the method, in particular any colorimetric data acquisition device.

1. Method for simulating an application of a make-up product (PM) to a body surface, comprising implementing a rendering engine (R) configured to apply a make-up effect comprising at least one colour transformation to at least a portion of incoming image data (X_S) comprising the body surface to be virtually made-up, and to generate transformed image data (X_V) simulating said application of make-up product according to at least one colour parameter (COL) characteristic of the make-up product to be virtually applied,
characterized in that it comprises a prior step of determining said characteristic colour parameter comprising:
acquiring a colour datum of said body surface to be virtually made-up (LIPS_P3);
acquiring a value of the characteristic colour parameter of the make-up product as a function of said colour data of the body surface to be virtually made-up.

2. Method according to claim 1, characterized in that the body area to be virtually made-up is a lip area, with the cosmetic make-up product (PM) being a lip make-up product, in particular a lipstick (LS C).

3. Method according to claim 1, characterized in that the colour data of the body surface (LIPS_P3) to be virtually made-up is acquired from the incoming image data (X_S).

4. Method according to claim 1, characterized in that the colour data of the body surface (LIPS_P3) to be virtually made-up is acquired separately from the incoming image data (X_S), in particular by a colour measurement using a colorimeter or spectrophotometer.

5. Method according to claim 1, characterized in that the incoming image data (X_S) are an image (I2) of the body area made-up with a make-up product having a particular desired finish or texture.

6. Method according to claim 1, characterized in that the colour parameter value (COL) is acquired from a database (DB) associating at least one cosmetic make-up product reference (PM LS C) with a plurality of reference colours (LIPS 1, LIPS 2, LIPS 3) of the considered body area.

7. Method according to claim 6, characterized in that the value of the colour parameter (COL) characteristic of the cosmetic product (PM) is selected from the database as being that assigned to the reference colour of the considered body area that is closest to the colour of the body area to be virtually made-up acquired from the incoming image data.

8. Method according to claim 1, characterized in that the value of the colour parameter (COL) characteristic of the cosmetic product (PM) is acquired by applying a colorimetric rendering model (KM) to an intrinsic colour datum of the considered cosmetic product and to a colour datum of the body area to be made-up acquired from the incoming image data (X_S).

9. Method according to claim 1, characterized in that a value of the colour parameter (COL) is acquired for different sub-areas of the body surface to be virtually made-up, and in particular for pixel-by-pixel colour processing.

10. Method according to claim 1, characterized in that the rendering engine (R) is able to receive a shine/matteness parameter.
